(19) United States
(12) Patent Application Publication
(10) Pub. No.: US 2024/0284931 A1
(43) Pub. Date: Aug. 29, 2024

(54) SOLUBLE COFFEE POWDER

(71) Applicant: SOCIETE DES PRODUITS NESTLE S.A., Vevey (CH)

(72) Inventors: ULRICH KESSLER, Savigny (CH); XIAOPING FU, Dublin, OH (US); JEREMIE CARTIER, Cuarny (CH); JULIEN DUPAS, Savigny (CH); HANS JORG WERNER LIMBACH, Epalinges (CH)

(21) Appl. No.: 18/571,885

(22) PCT Filed: Jun. 14, 2022
(86) PCT No.: PCT/EP2022/066192

§ 371 Date: Dec. 19, 2023

(30) Foreign Application Priority Data
Jun. 21, 2021 (EP) 21180497.6

(51) Int. Cl. A23F 5/32; A23F 5/38

(52) U.S. Cl. CPC A23F 5/32; A23F 5/38

(57) ABSTRACT

The present invention relates to a coffee powder for providing a coffee beverage with crema. Further aspects of the invention are the use of a coffee powder to prepare a beverage: a beverage powder mixture and a method for the manufacture of a freeze-dried coffee powder.

### FIELD OF THE INVENTION

The present invention relates to a coffee powder for providing a coffee beverage with crema. Further aspects of the invention are the use of a coffee powder to prepare a beverage; a beverage powder mixture and a method for the manufacture of a freeze-dried coffee powder.

### BACKGROUND OF THE INVENTION

Soluble or “instant” coffee is a phrase used to describe a powder which produces a coffee beverage on reconstitution with water, thus avoiding the more complicated and time-consuming process of preparing a beverage from traditional roast and ground coffee. Typically, soluble coffees are manufactured by first producing a coffee extract by roasting, grinding and extracting the roasted beans, then removing water from the extraction brew to form a powdered product. The water removal is generally achieved by freeze-drying or spray-drying.

However, unlike coffee beverages prepared from roast and ground coffee, those prepared from soluble coffee do not usually exhibit a fine foam on their upper surface when reconstituted with hot water. The foamed upper surface in beverages prepared from roast and ground coffee are typically associated with and caused, at least in part, by the machines which brew with pressurised water and/or steam.

This foam is known to positively affect the mouthfeel of the product when consumed and so is highly desired by many consumers. Furthermore, the foam acts to keep more of the volatile aromas within the beverage so that they can be appreciated by the consumer rather than lost to the surrounding environment. The foam is often referred to as crema.

A number of techniques are known to trap gas in soluble coffee powder to form crema on reconstitution, but these typically use spray-drying since the method lends itself to the formation of closed pores. EP0839457 describes foaming a coffee extract by gas injection, homogenizing the foamed extract to reduce gas bubble size and spray-drying the homogenized extract.

In contrast to the closed pores of gassed spray-dried powders, conventional freeze-dried powders have mainly open pores. Open pores are created during drying of the frozen extract, the pores being the area previously occupied by an ice crystal and the open channels being the exit paths of the sublimated water.

Spray-dried coffee powders are considered by some consumers to have an inferior aroma profile in comparison with freeze-dried powders. This is because the spray-drying process leads to greater loss of coffee volatiles compared to freeze-drying. The quality of spray-dried coffees has greatly increased over recent years with the advent of improved aroma capture techniques, but the perception that freeze-dried coffee provides superior quality remains with some consumers.

The process of freeze-drying coffee extracts usually includes gassing the extract to form a foam before the freezing, for example as described in GB1102587. This is done to increase the drying rate and to control the density of the resulting powder. Such gassing processes do not lead to a soluble coffee providing significant crema.

WO2017/186876 describes a freeze-dried coffee powder with a closed porosity of less than 15% that produces some crema on reconstitution. The production method involves slow freezing of coffee extract to grow large ice crystals which result in open pores when the extract is dried. However, long freezing times reduce production efficiency.

Many soluble coffee powders that produce foam are still lacking insofar as the foam initially produced is not conserved during consumption or the structure resembles a coarse foam rather than a fine and smooth (velvety) foam, ultimately desired by consumers. Alternatively or additionally, there may simply be insufficient foam produced upon reconstitution of the powder and/or the foam does not cover the whole beverage surface.

Hence, there is a persisting need in the art to find better solutions to provide soluble coffee powder that delivers crema on reconstitution.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state of the art and to provide an improved solution to overcome at least some of the inconveniences described above. The object of the present invention is achieved by the subject matter of the independent claims. The dependent claims further develop the idea of the present invention.

Accordingly, the present invention provides in a first aspect a coffee powder for providing a coffee beverage with crema, the coffee powder comprising particles having open and closed pores, the particles having an open pore volume mean diameter greater than 4 micrometres, a total open pore volume greater than 1 ml/g and a foaming porosity of 30% or greater.

In a second aspect, the invention relates to the use of the coffee powder of the invention to prepare a coffee beverage having crema.

A further aspect of the invention is a method for the manufacture of a freeze-dried coffee powder, the method comprising;
providing a coffee extract having from 50 wt % to 70 wt % solids;
adding gas to the coffee extract in an amount of from 0.5 to 3 normal litres per kilogram of solids, to provide a gas-containing coffee extract at above atmospheric pressure;
cooling the gas-containing coffee extract to a temperature of −10 to 10° C.;
depressurising the gas-containing coffee extract to form a foamed coffee extract;
adding crystals of a material capable of sublimation to the foamed coffee extract at a temperature of −10 to 10° C. to form a mixture comprising foamed coffee extract and crystals of a material capable of sublimation;
cooling the mixture comprising foamed coffee extract and crystals of a material capable of sublimation to below −30° C. to form a solid coffee extract;
fragmenting the solid coffee extract; and
placing the solid coffee extract under conditions wherein the crystals of a material capable of sublimation sublime.

High levels of closed porosity generates foam in spray-dried coffee powders. However, applying the same approach to freeze-dried coffee powders has been unsuccessful. Freeze-dried coffee powders with high levels of closed pores simply float to the top of the beverage, which is unattractive to consumers. This behavior is due to the slower dissolution of freeze dried powders.

The inventors have found that by gassing coffee extract at a high solids content they can maximize the formation of pores that generate foam, for example closed pores. However high solid content extracts contain less water and so produce less ice on freezing during the production of freeze-dried coffee. With less ice formation, fewer open pores are created and so a freeze-dried powder does not dissolve rapidly and tends to float. The floating particles do not generate good crema and are unsightly. The inventors have surprisingly found that by adding pre-formed ice crystals to the high solids extract after gassing they are able to form a freeze-dried coffee powder that has enhanced levels of closed pores, generates good crema and also dissolves rapidly. The microstructure of the resulting powder shows a combination of high levels of foaming porosity and sufficient larger open pores to aid dissolution.

### BRIEF DESCRIPTION OF THE DRAWINGS

FIG. 1 is a plot of t90, time to 90% dissolution in seconds (x-axis), versus open pore volume in ml/g, measured by mercury intrusion at a pressure of 40 psia (y-axis).

FIG. 2 is a plot of t90, time to 90% dissolution in seconds (x-axis), versus median open pore diameter in micrometres, measured by mercury intrusion (y-axis).

FIG. 3 is a diagram of the equipment used to measure the crema volume of the samples, wherein (3.1) is a plastic scale for reading the foam volume, (3.2) is a water reservoir, (3.3) is the lid of the reconstitution vessel, (3.4) is a connection valve, (3.5) is the reconstitution vessel and (3.6) is the release valve.

FIGS. 4 and 5 are scanning electron microscope images of a coffee granule that contains closed pores (a), voids from ice sublimation (b) and voids from ice crystal addition (c)

### DETAILED DESCRIPTION OF THE INVENTION

Consequently the present invention relates in part to a coffee powder for providing a coffee beverage with crema, the coffee powder comprising (for example consisting of) particles (for example soluble particles) having open and closed pores, the particles having an open pore volume mean diameter greater than 4 micrometres, for example greater than 5 micrometres, for example greater than 6 micrometres, for example greater than 7 micrometres, for further example greater than 8 micrometres (for example as measured by mercury porosimetry), a total open pore volume greater than 1 ml/g, for example greater than 1.1 ml/g, for example greater than 1.2 ml/g, for example greater than 1.3 ml/g, for further example greater than 1.4 ml/g (for example as measured by mercury porosimetry) and a foaming porosity of 30% or greater (for example as measured by mercury porosimetry).

A coffee powder is a powder which produces a coffee beverage on reconstitution with water. An example of a coffee powder is the powdered, dried, water-extract of roasted, ground coffee. The coffee powder may be instant soluble coffee. Usually a coffee powder consists of particles of coffee materials. Many food regulations prohibit components other than coffee materials in a soluble coffee. In an embodiment, the coffee powder may be free from insoluble roasted ground coffee.

In the context of the present invention, the term “open pores” is used to define voids present in the particles, the voids having a connection to the surface of the particle. The term “closed pores” is used to define completely closed voids. Thus liquids such as water may not penetrate into the closed pores before the particle dissolves.

“Volume mean diameter” is the mean value of diameter on a volume basis, sometimes referred to as D[4,3]. The open pore volume mean diameter is the volume mean diameter of the open pores. The open pore mean diameter may be measured by mercury porosimetry. The inventors have found that the dissolution speed of the particles increases with open pore volume mean diameter (see Example 3). In an embodiment, the coffee powder comprises particles having an open pore volume mean diameter between 4 and 15 micrometres, for example between 5 and 14 micrometres, for further example between 6 and 9 micrometres.

In some coffee powders, individual particles are agglomerated with other particles to form agglomerates or granules. For example, the particles may be agglomerated using a sintering process. In such agglomerates there may be a bimodal distribution of open pore volume; the smaller open pores in the original particles, and the larger open void spaces between individual original particles in their agglomerated structure.

In an embodiment, the particles according to the invention have a bimodal open pore diameter distribution wherein the open pore volume mean diameter of the mode comprising the smaller diameters is greater than 4 micrometres for example greater than 5 micrometres, for example greater than 6 micrometres, for example greater than 7 micrometres, for further example greater than 8 micrometres (for example as measured by mercury porosimetry).

In an embodiment, the particles according to the invention have a monomodal open pore diameter distribution.

The total open pore volume is the volume of open pores per gram of product in the diameter range 0.02 to 500 micrometres (equivalent to mercury intrusion pressure from 9000 psia to 0.3 psia). In an embodiment, the coffee powder comprises coffee particles having a total open pore volume between 1 ml/g and 1.8 ml/g.

As previously discussed, closed pores contribute to crema generation. Without wishing to be bound by theory the inventors believe that open pores with an opening diameter of less than 2 micrometres also contribute to foam since the capillary pressure in these pores is greater than the ambient pressure and this may enable foam formation. The foaming porosity may be measured by a combination of mercury porosimetry and helium pycnometry. The foaming porosity may be measured by mercury porosimetry, for example as described in Example 3. The term “foaming porosity” relates to the sum of the closed pores and the open pores having an opening diameter of less than 2 micrometres.

$$Foaming porosity ( \% ) = \frac{{V}_{c} + {V}_{0 < 2 μ m}}{{V}_{c} + {V}_{m} + {V}_{0}}$$

Where: Vₘ=coffee matrix volume
V_{c}=volume of closed pores
V_{0<2 μm}=volume of open pores having an opening less than 2 μm
V₀=total volume of open pores

The volume of closed pores, V_{c}, may be measured by using a gas displacement pycnometer, for example, the skeletal (apparent) density of a coffee powder may be determined by measuring the volume of a weighed amount of powder using a gas displacement pycnometer and dividing the weight by the volume. The ratio of the mass of the coffee powder to the sum of the volume including closed (or blind) pores. The skeletal density is a measure of density that includes the volume of any void present in the powder that are sealed to the atmosphere and excludes the volume of any voids open to the atmosphere. The closed pore volume, V_{c}, is determined by subtracting the reciprocal coffee matrix density from the reciprocal skeletal density. The coffee matrix density is sometimes referred to as the “true density” of the solid material forming the coffee powder.

The coffee matrix density may be measured by grinding the coffee powder particles to open all internal voids. For example, the coffee powder particles may be ground in a cryo-mill. A cryo-mill has the advantage that the low temperature aids in fracturing the particles and prevents thermal degradation of the powder during milling. The density obtained by pycnometry of the ground powder is the coffee matrix density. The coffee matrix volume, Vₘ, for a given weight of coffee powder is the inverse of the coffee matrix density dₘ. Another method to obtain the coffee matrix density is to measure the density of liquid coffee at different concentrations and extrapolate to the coffee matrix density value at the relevant low moisture content.

The foaming porosity of the particles according to the present invention (for example as measured by mercury porosimetry) may be at least 30%, for example at least 32%, for example at least 35%, for further example at least 40%. The foaming porosity (for example as measured by mercury porosimetry) may be between 30 and 60%, for example between 32 and 50%, for further example between 35 and 45%.

The volume of closed pores, V_{c}, and their size distribution may be measured by X-ray tomography with the X-ray tomography images analysed by image analysis software. For example Geodict software (Math2Market) may be applied to high-resolution images to analyse the pore size distribution of closed pores. The pores may be distinguished from the walls by applying an Auto-thresholding (OTSU method). The individual pore analysis may be performed using the “individual pores” function, selecting a threshold of 0% to consider only the pores not connected with the external surfaces. The volume mean D_{4,3}^{c} and median D₅₀^{c} equivalent diameter and the median sphericity of the closed pores may then be calculated from the individual pore size analysis.

In an embodiment the mean Volume diameter D_{4,3}^{c} of the closed pores of the particles according to the invention (for example as measured by X-ray tomography) is from 1 to 25 μm, for example 2 to 20 μm, for example 4 to 10 μm.

The unique structure of the particles comprised within the coffee powder of the invention provides an advantageous balance between pores having the potential to generate crema on dissolution of the powder, and pores enhancing dissolution so as to maximize the volume and quality of the crema produced. Fast dissolution provides better surface foam coverage for the same foaming porosity. With slow dissolution, the particles float to the surface where they are visible to the consumer as unsightly black spots and do not generate satisfactory foam when they finally dissolve.

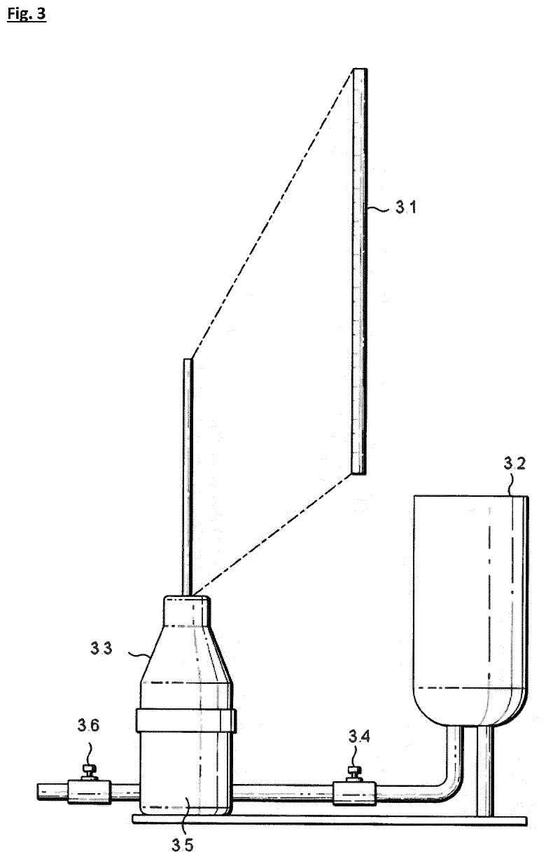

In an embodiment of the coffee powder of the invention, the coffee powder provides a beverage with crema of at least 2.5 mL, for example at least 3 mL, for example at least 4 mL, for example at least 5 mL, when using 5 g of coffee powder in 200 ml of deionised water at 85° C. The crema may be measured after 1 minute. The amount of crema produced can be measured with a simple device (FIG. 3) consisting of a reconstitution vessel connected to a water reservoir, which is initially blocked off with a valve. After reconstituting, the reconstitution vessel is closed with a special lid that ends in a scaled capillary. The valve between the reconstitution vessel and the water reservoir is then opened and the water (standard tap water) pushes the reconstituted beverage upwards into the capillary, thus facilitating the reading of the crema volume. The crema may be at a temperature of 25° C. when its volume is measured. An embodiment of the invention is a coffee powder for providing a coffee beverage with a crema of at least 0.5 mL/g on reconstitution in water, for example at least 0.6, 0.8 or 1.0 mL/g on reconstitution with water.

In an embodiment the coffee powder is a freeze-dried coffee powder. A freeze-dried coffee powder is an instant coffee obtained by freeze-drying an extract (for example an aqueous extract) of coffee, usually roast and ground coffee. The coffee may be arabica coffee (Coffea arabica), robusta coffee (Coffea canephora) or a blend of arabica and robusta coffee.

The extract may be provided by an extraction process that promotes a degree of hydrolysis of the coffee. Chemical transformations in roast and ground coffee such as hydrolysis may occur during extraction, for example cleavage of large molecular mass polysaccharides resulting in their solubilisation.

The coffee powder of the invention has an attractive appearance and good dissolution without requiring agglomeration. The coffee powder may not have been agglomerated. For example the coffee powder may not have been subjected to a sintering process. In an embodiment, neither the coffee powder nor its components have been subjected to a sintering process. In an embodiment, the coffee powder is a non-sintered powder.

In an embodiment the coffee powder has a dissolution time t90 (time for 90% dissolution) from 2 to 15 s.

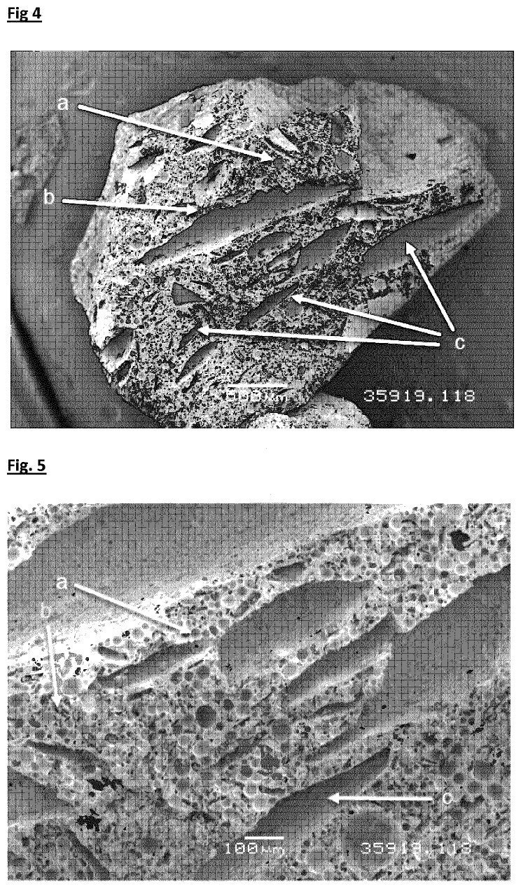

The addition of pre-formed ice crystals to coffee extract before freeze-drying creates a freeze-dried coffee powder that has a distinctive open pore structure. The voids left by the added ice crystals can be clearly observed in FIGS. 4 and 5 (labeled as “c”). This open pore structure provides rapid dissolution. The size and shape of the voids left by added ice may be measured by X-ray tomography, with the X-ray tomography images analysed by image analysis software. Geodict software (Math2Market) may be used on low-resolution images to analyse the 3D structure of the particles. The different populations of pores are segmented as a function of sphericity values. A Non-Local Means filter is first applied to the images. The pores are distinguished from the walls by applying an Auto-thresholding (OTSU method). The particle is then contoured using the function “flood fill large pores” (200 voxels). The individual pore analysis is performed using the “individual pores” function, for example selecting a threshold of 14%. The identified pores are then filtered according to two criteria: sphericity below 0.7 and individual equivalent diameter above 25 μm. The resulting list of pores visually corresponds to the added ice. In an embodiment the particles comprise open pores formed by added ice (for example as measured by X-ray tomography) having a mean volume diameter D_{4,3}ⁱ of from 50 to 1000 μm, for example from 100 to 1000 μm, for example from 200 to 500 μm, for example from 90 to 250, for example from 110 to 210 μm. In an embodiment, the particles comprise pores (for example open pores) having a sphericity below 0.7 and an individual equivalent diameter above 25 μm; wherein said pores having a sphericity below 0.7 and an individual equivalent diameter above 25 μm have a mean volume diameter D_{4,3} of from 50 to 1000 μm, for example from 100 to 1000 μm, for example from 200 to 500 μm, for example from 90 to 250, for example from 110 to 210 μm, as measured by X-ray tomography.

Closed pores contribute to crema generation in a particle that has appropriate dissolution properties. In an embodiment the particles have a closed porosity of 8% or greater (for example as measured by helium pycnometry), for example 10% or greater, for example 12% or greater, for example 15% or greater, for example 15.5% or greater, for example 17% or greater, for further example 20% or greater. The closed porosity may be measured by using a helium pycnometer, for example by measuring the skeletal density dₛ and coffee matrix density dₘ, for example as described in Example 2. The skeletal density dₛ may for example be measured by using a gas displacement pynometer with helium gas, a measurement pressure of 134 kPag (kPa gauge) and an equilibration criteria setting of 0.6895 kPag/min. The coffee matrix density dₘ may be measured in the same way, but by first grinding the coffee powder particles to open all internal voids. The coffee powder particles may be ground to open all internal voids using a cryo-mill, for example for a period of 8 minutes.

$$Closed porosity ( \% ) = 100 \times ( 1 - \frac{skeletal density}{matrix density} )$$

As discussed above, open pores with opening diameter of less than 2 micrometres may contribute to foam generation on dissolution. In an embodiment, the particles have an open pore volume having an opening less than 2 micrometres (V_{0<2 μm}) greater than 0.2 ml/g. For example the particles according to the invention may have an open pore volume having an opening less than 2 micrometres greater than 0.25 ml/g, for further example greater than 0.3 ml/g. The particles according to the invention may have an open pore volume having an opening less than 2 micrometres of between 0.2 and 0.45 ml/g. The open pore volume having an opening less than 2 micrometres (V_{0<2 μm}) may be measured by mercury porosimetry, for example as described above. In an embodiment the particles have open pores with openings smaller than 2 micrometres, the volume of the open pores with openings smaller than 2 micrometres being greater than 17%, for example greater than 19%, of the total volume of open pores (for example as measured by mercury porosimetry).

In an embodiment, the particles comprise open and closed pores, together the open and closed pores having an overall pore size distribution with a volume median diameter Dv50 of from 10 to 100 micrometres, for example 30 to 50 micrometres, for example 10 to 45 micrometres, for example 11 to 35 micrometres, for example 12 to 30 micrometres, for example 13 to 25 micrometres, for further example 14 to 20 micrometres. The pore size distribution may be measured by x-ray tomography, based on the void volume distribution. For example low-resolution tomography of the particles may be performed using x-ray beam energy of 12 keV, sample-to-detector distance of 5 mm and a detector with an effective isotropic voxel size of 1.625 μm. Geodict software (Math2Market) may be applied to the low-resolution images to analyse the microstructure of open and closed pores. A Non-Local Means filter is first applied to the images. The pores are distinguished from the walls by applying an Auto-thresholding (OTSU method) and a mask is applied to focus on the full imaged particle. The granulometry method (PoroDict module) is performed to extract the overall size statistics of all the pores.

In an embodiment, the particles comprise open and closed pores, together having a pore size distribution characterised by a distribution span factor between 0.5 and 9, for example between 1 and 8, for example between 1.1 and 7, for example, between 1.2 and 6, for example between 1.3 and 5, for example between 1.4 and 4, for example between 1.3 and 3, for example between 1.4 and 2, for further example between 1.5 and 1.9. The distribution span factor may be measured by x-ray tomography. The span of the distribution is calculated by the following equation:

$$Span = \frac{Dv 90 - Dv 10}{Dv 50}$$

wherein Dv90, Dv50 and Dv10 represent the equivalent pore diameter which 90%, 50% and 10%, respectively, of the pores by volume have a size lower or equal to. Thus, the lower the span, the narrower and more homogeneous the distribution of the pores.

The inventors have found that a high proportion of open pores having an opening larger than around 4.4 micrometres provides rapid dissolution. Using mercury porosimetry, a pressure of 40 psia is required to penetrate a pore opening of 4.4. micrometres. In an embodiment, the particles have a structure such that 60% or more intrusion of the particles is achieved under a pressure of 40 psia by mercury porosimetry.

However, the inventors found that, for best crema generation, a proportion of smaller pores should be present. In an embodiment, the particles have a structure such that from 60 to 85% intrusion of the particles is achieved under a pressure of 40 psia by mercury porosimetry. For example the particles may have a structure such that from 50 to 80%, for example from 60 to 75%, for further example from 65 to 70% intrusion of the particles may achieved under a pressure of 40 psia by mercury porosimetry. The addition of ice crystals before freeze-drying coffee extract allows the formation of such desirable structures.

An aspect of the invention provides a pack, for example a single-serve pack, containing the coffee powder of the invention. The single serve pack may for example be a capsule, pod or stick-pack.

An aspect of the invention provides for the use of the coffee powder of the invention to prepare a coffee beverage having crema. For example, the use of the coffee powder of the invention to prepare a coffee beverage having at least 2.5 ml of crema, for example at least 3 mL, for example at least 4 mL, for example at least 5 mL, when using 5 g of coffee powder in 200 ml of deionised water at 85° C. The crema may be measured after 1 minute. The crema gas volume may be measured at a temperature of 25° C. An embodiment of the invention is the use of the coffee powder of the invention for providing a coffee beverage with a crema of at least 0.5 ml/g on reconstitution in water, for example at least 0.6, 0.8 or 1.0 mL/g on reconstitution with water.

A further aspect of the invention provides a beverage powder mixture comprising the coffee powder of the invention. The beverage powder mixture may be for example a powder mixture comprising a component selected from the group consisting of sugar, milk powder, “plant milk” powder (for example oat milk, almond milk, soy milk, coconut milk), creamer (including non-dairy creamer) and combinations of these.

A further aspect of the invention provides a method for the manufacture of a freeze-dried coffee powder, the method comprising;
providing a coffee extract having from 50 wt % to 70 wt % solids;
adding gas to the coffee extract in an amount of from 0.5 to 3 normal litres per kilogram of solids, to provide a gas-containing coffee extract at above atmospheric pressure (for example at 50 to 400 bar gauge, for further example 150 to 350 bar gauge);
cooling the gas-containing coffee extract to a temperature of −10 to 10° C.; depressurising the gas-containing coffee extract to form a foamed coffee extract;
adding crystals of a material capable of sublimation to the foamed coffee extract at a temperature of −10 to 10° C. to form a mixture comprising foamed coffee extract and crystals of a material capable of sublimation;
cooling the mixture comprising foamed coffee extract and crystals of a material capable of sublimation to below −30° C. (for example below −40° C.) to form a solid coffee extract;
fragmenting the solid coffee extract; and
placing the solid coffee extract under conditions wherein the crystals of a material capable of sublimation sublime.

The coffee extract according to the invention may be an aqueous coffee extract suitable for further processing into pure soluble coffee. Roasted coffee beans may be extracted with water to produce a coffee extract. The roasted beans are usually ground before being extracted with water. Grinding of roasted coffee beans are well known in the art and the roasted coffee beans may be ground by any suitable method. Extraction may be performed by any suitable method known in the art. Methods for extracting coffee beans are well known in the art of production of soluble coffee, e.g. from EP 0826308, and normally involve several extraction steps at increasing temperature. When the desired degree of extraction has been reached, the extracted roast coffee beans are separated from the extract. The separation may be achieved by any suitable means, e.g. filtration, centrifugation, and/or decanting. In conventional coffee extraction for the production of soluble coffee, the separation is usually achieved by performing the extraction in extraction cells wherein the coffee grounds are retained by filter plates or retainer plates through which the coffee extract can flow. Before and/or during extraction, volatile aroma compounds may be recovered from the coffee beans and/or the extract, e.g. by steam stripping and/or the use of vacuum, to avoid loss of aroma. The recovered volatile compounds may be added back to the extract after extraction.

The coffee extract may be an extract of roasted Arabica coffee beans, Robusta coffee beans or combinations of these. Coffee beans are the seeds of the coffee plant (Coffea). By Arabica coffee beans are meant coffee beans from Arabica coffee plants (Coffea arabica) and by Robusta coffee beans are meant beans from Robusta coffee plants (Coffea canephora).

The solids content of the extract is the weight of dry matter as a percentage of the total weight of the extract on a wet basis. Various methods are available for increasing the solids content of a coffee extract. For example water may be evaporated under vacuum from the coffee extract, usually with aroma capture; water may be removed via membrane concentration; and/or additional solid coffee extract may be dissolved in aqueous coffee extract. In an embodiment, the coffee extract having from 50 wt % to 70 wt % solids is the result of adding dried pure soluble coffee to an aqueous coffee extract.

In an embodiment the coffee extract is subjected to high pressure (for example at 50 to 400 bar gauge, for further example 80 to 300 bar gauge, for further example 120 to 250 bar gauge) by a high pressure pump. Prior to and/or after the high pressure pump, gas may be added to the coffee extract. Gas may be added by means of a gas addition line where the gas is above the pressure of the coffee extract (for example slightly (e.g. up to 10%) above the pressure of the coffee extract). The gas may be selected from the group consisting of nitrogen, air, argon, nitrous oxide and carbon dioxide. Preferably the gas is nitrogen due to its tendency to form smaller, more stable bubbles. The gas is dissolved in the coffee extract, for example by ensuring sufficient residence time in the coffee extract. For example, the gas may have a residence time of at least 60 seconds before the gas-containing coffee extract is depressurized. The term “gas” is used in the current specification for simplicity, but it should be noted that a gas such as nitrogen would be in the form of a supercritical fluid under some conditions of the method.

The gas is added to the coffee extract in an amount of from 0.5 to 3 normal litres per kilogram of coffee extract solids, for example an amount of from 1 to 2.8 normal litres per kilogram of coffee extract solids. The quantity of gas in a normal litre is that which would occupy one litre volume at 20° C. and 1 atmosphere (101.325 kPa), pressure. The amount of gas added influences the gas bubble void amount in the final coffee powder.

The gas-containing coffee extract is cooled to a temperature of −10 to 10° C. (for example −7 to 8° C., for example −6 to 7° C., for example −5 to 7° C., for further example 0 to 6° C.). Preferably the gas-containing extract is cold enough to not cause excessive melting of the crystals of a material capable of sublimation when these are added. The gas-containing coffee extract may be cooled to a temperature above the coffee extract's freezing point. The gas-containing coffee extract may for example be cooled to a temperature from 3° C. below the coffee extract's freezing point to 5° C. above the coffee extract's freezing point. Cooling the gas-containing coffee extract may be performed before or after depressurising the gas-containing coffee extract to form a foamed coffee extract. Cooling may for example be performed using a scraped-surface heat exchanger. Cooling the gas-containing coffee extract before depressurisation helps control the foam structure as it reduces the opportunity for bubble coalescence in the foam. Depressurization may be performed through a sparging or atomization nozzle.

The material capable of sublimation according to the invention may be water or carbon dioxide. In an embodiment, the crystals of a material capable of sublimation may comprise, for example consist of, water ice.

The crystals of a material capable of sublimation are added to the foamed coffee extract at a temperature of −10 to 10° C. (for example −7 to 8° C., for example −6 to 7° C., for example −5 to 7° C., for further example 0 to 6° C.). The crystals of a material capable of sublimation may for example be added to the foamed coffee extract at a temperature from 3° C. below the coffee extract's freezing point to 5° C. above the coffee extract's freezing point.

The crystals of a material capable of sublimation may be added to the foamed extract in a mixer. Sufficient shear is required to mix the crystals into the foamed extract effectively, but care should be taken to limit damage to the foam structure and to avoid heating the mixture. In an embodiment, the crystals of a material capable of sublimation are at a temperature from −40° C. to −10° C. when they are added to the foamed coffee extract. The addition of the crystals may cause the temperature of the gas-containing coffee extract to decrease. For example, the gas-containing coffee extract may be cooled by the addition of the crystals of a material capable of sublimation, for example during mixing of the crystals of a material capable of sublimation with the gas-containing coffee extract under moderate shear. The shear rate applied during mixing may be at least 50 s⁻¹, for example at least 100 s⁻¹, for example at least 200 s⁻¹. Porous spray dried particles of dried coffee extract having high levels of closed pores (for example greater than 20% closed porosity) may also be added to the foamed coffee extract to contribute to the closed porosity of the coffee powder obtained by the method of the invention.

The mixture comprising foamed coffee extract and crystals of a material capable of sublimation is cooled to below −30° C. to form a solid coffee extract, for example a frozen coffee extract. A solid coffee extract has structural rigidity. The mixture may be cooled by depositing it in trays which are moved between cold rooms or other zones held at different temperatures. The mixture may be cooled by passing it through a heat exchanger or over a cooling drum. The mixture may be cooled from a temperature of −5° C. down to a temperature of −30° C. in a period of less than 30 minutes, for example less than 20 minutes, for example less than 10 minutes, for example less than 6 minutes. Rapid cooling ensures that the larger crystals in the solid extract predominately originate from the added crystals. For the crystals that grow during cooling rather than being added, rapid cooling produces smaller crystals. The crystal addition and cooling rate may be controlled to optimize the microstructure of the freeze-dried coffee powder.

The solid coffee extract may be fragmented before and/or after being placed under conditions wherein the crystals of material capable of sublimation sublime.

The conditions wherein the crystals of a material capable of sublimation sublime may be a vacuum. Sublimation is the act of a solid changing directly into vapour, for example ice turning directly into water vapour without passing through the liquid phase.

In an embodiment the ratio of crystals capable of sublimation to coffee extract is in the range 5 to 40 wt. %, for example in the range 10 to 30 wt. %. The ratio is calculated on a wet basis of the coffee extract weight. The ratio is set to control the balance between added crystals and crystals which grow during freezing so as to optimize the microstructure in terms of dissolution speed and maintenance of foaming pores.

In an embodiment the crystals of a material capable of sublimation are ice, the solid coffee extract is frozen coffee extract and sublimation is performed under vacuum. The coffee extract may be placed on trays in cabinets under a vacuum of <1 mbar for a period of up to 7 hours.

In an embodiment the ice has a mean volume diameter from 45 to 2000 μm, for example 50 to 1700 μm, for example 50 to 1500 μm, for further example from 150 to 1000 μm. The ice may have a mean aspect ratio b/l₃ from 0.5 to 0.7. The mean volume diameter and mean aspect ratio may for example be measured by laser diffraction. The ice may for example be prepared by using an ice shaver to produce small water ice particles from an ice block. The ice may be ground and sifted to obtain the desired size and shape.

In an embodiment, the crystals of a material capable of sublimation may be ice and the ice may be added in the form of a frozen aroma extract, for example a frozen aqueous aroma extract obtained (for example recovered) during the processing of a coffee extract. The frozen aroma extract may contain some coffee extract solids, for example between 5 and 15 wt. % coffee solids.

Those skilled in the art will understand that they can freely combine all features of the present invention disclosed herein. In particular, features described for the product of the present invention may be combined with the method of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1: Coffee Powder Preparation

Coffee liquor extract was conveyed and pressurised with a high pressure piston pump to around 220 bar. Nitrogen was injected shortly after the high pressure pump. The gassed extract passed a defined length of pipe to ensure enough residence time (e.g. above 60 s) to dissolve the nitrogen. The extract passed through a spray nozzle to release the pressure to atmospheric pressure and form a foam.

The foamed extract was cooled using a scraped surface heat exchanger to a temperature above its freezing point without any addition of gas.

An ice shaver was used to produce small water ice particles from an ice block. The ice was then ground in an Urschel CC slicer with a SL 8 head and sifted. The ice powder was stored in a cold room at temperatures below −40° C. until required.

Ice powder prior to addition was characterized in size and shape using the Camsizer X2 equipment (Retsch) mounted with the X-Jet module. The powder was kept at −20° C. and ice was directly introduced in the air dispersion unit (300 kPa, gap of 9 mm) via a spoon without using the tray to avoid particles melting before the measurement. At least one million particles were recorded by the system. The mean volume diameter D_{4,3} (called Mᵥ₃ by the Camsizer software) and mean aspect ratio b/l₃ were extracted from the Camsizer software.

The ice had a mean volume diameter D_{4,3} of 590 μm and mean aspect ratio b/l₃ of 0.619.

A weighed amount of ice powder was added to the foamed extract and mixed. A medium level of shear was applied, sufficient to ensure good mixing but without promoting significant ice melting. During mixing in of the ice, the temperature of the foamed extract dropped. The foamed extract with added ice was then further cooled to below −40° C., forming a frozen layer. This frozen extract was ground before being freeze-dried using an Atlas freeze dryer. The final particle size was measured using laser diffraction. All samples had a particle size in the range d50 of 2.0 to 2.5 mm.

Process parameters for 7 samples are given in the table below.

| | | | B | | | | | E | | | | |
|---|---|---|---|---|---|---|---|---|---|---|---|---|
| Sample | A | | (comparative) | C | | D | | (comparative) | F | | G | |
| Extract dry matter | 55.8% | | 57.5% | 57.5% | | 57.5% | | 57.5% | 57.5% | | 57.5% | |
| Temperature at | 42° | C. | 45° C. | 45° | C. | 45° | C. | 45° C. | 45° | C. | 45° | C. |
| pressurization | | | | | | | | | | | | |
| Gassing level | 1.5 | | 1.98 | 1.98 | | 1.98 | | 1.98 | 1.98 | | 1.98 | |
| (normal litres N₂/ | | | | | | | | | | | | |
| kg extract solids) | | | | | | | | | | | | |
| Temperature after | 2-3° | C. | 4° C. | 4° | C. | 4° | C. | 5° C. | 5° | C. | 5° | C. |
| cooler | | | | | | | | | | | | |
| Ice (% weight of | 19 | | 0 | 10 | | 20 | | 0 | 10 | | 20 | |
| foamed extract) | | | | | | | | | | | | |
| Temperature after | −3° | C. | — | −6.5° | C. | −8.5° | C. | — | −3° | C. | −7° | C. |

ice addition

### Example 2: Method of Measuring Closed Porosity with He Porosimetry

The skeletal density dₛ of the coffee particles of Sample A was measured with a gas displacement pycnometry System (AccuPyc 1340, Micromeritics). The measurement cell of the pycnometer was filled at two-thirds of its volume and the sample weight recorded. The following parameters were used: 10 purges, purge and measurement pressure of 134 kPag; average of 3 runs. The volume of gas that penetrates into the measurement chambers allows the computation of the skeletal density in g/cm³ by the equipment. Skeletal density is a measure of the material density that includes closed voids in the particles but excludes all the voids that are open to the atmosphere (open porosity and interstitial voids between particles). The skeletal density was initially measured with a gas displacement pycnometer and nitrogen gas, as nitrogen has lower tendency to diffuse into the matrix material than helium, making it easier to achieve stringent equilibration criteria. The equilibration criteria for nitrogen was set at 0.0345 kPa/min (called “equilibration rate” in the instrument software). With this setting, the skeletal density for Sample A was measured as 1.201 g/cm³. The sample was then measured with helium gas, which is more commonly used for pycnometry. The equilibration criteria setting was 0.6895 kPag/min. The skeletal density for Sample A, measured with helium was 1.203 g/cm³.

Closed porosity of the sample is then deduced by dividing the skeletal density dₛ by the coffee matrix density dₘ

$$Closed porosity ( \% ) = 100 \times ( 1 - \frac{{d}_{s}}{{d}_{m}} )$$

The coffee matrix density was measured by grinding the sample for 8 minutes in a SPEX Sample Prep 6875 freezer mill and then performing helium pynometry as above.

With a coffee matrix density of 1.540 g/cm³, and a skeletal density of 1.203 g/cm³, the closed porosity of Sample A was calculated as 21.9%. The closed porosities of the other samples were measured in the same way and are listed in the table below, together with that of a commercial freeze-dried coffee advertised as generating crema (PriorArt i).

| Sample | PriorArt i | A | B (comp.) | C | D | E (comp.) | F | G |
|---|---|---|---|---|---|---|---|---|
| Closed porosity | 12.2% | 21.9% | 15.4% | 22.2% | 24.0% | 14.9% | 21.5% | 24.5% |

### Example 3: Method of Measuring Pore Structure with Mercury Porosimetry

AutoPore IV 9520 was used for structure evaluation (Micromeritics Inc. Norcrose, Ga., USA). The operation pressure for Hg intrusion was from 0.4 psia to 9000 psia (with low pressure from 0.4 psia to 40 psia and high pressure port from 20 to 9000 psia). The pore diameter under this pressure is ranged from 500 to 0.01 micrometres. The data reported is total pore volume and pore volume (ml/g) at different pore opening diameters (μm). About 0.1 to 0.4 g of sample is precisely weighted and packed in a penetrometer (volume 3.5 ml, neck or capillary stem diameter 0.3 mm and stem volume of 0.5 ml).

After the penetrometer is inserted into the lower pressure port, the sample is evacuated at 1.1 psia/min initially, switching to a medium rate at 0.5 psia and to a fast rate at 900 μm Hg. The evacuating target is 60 μm Hg. After reaching the target, the evacuation is continued for 5 min before Hg is introduced.

The measurement is conducted in set-time equilibration. That is, the pressure points at which data are to be taken and the elapsed time at that pressure in the set-time equilibration (10 sec) mode. Roughly, 140 data points are collected at the pressure ranges.

The volume of open pores per gram of product in the diameter range 1 to 500 micrometres gives the “open pore Volume’.

The baseline value was obtained by running the corresponding empty penetrometer under the same operation conditions of pressure for Hg intrusion, from 0.4 psia to 9000 psia without any sample.

The bulk volume of the granulate is obtained from the initial volume of mercury and the sample holder. The volume of the open pores with opening diameter greater than 2 micrometres is obtained after intrusion with mercury up to a diameter of 2 micrometres. (A mercury intrusion pressure of 90 psi is required to penetrate pores of 2 micrometres.) Subtraction of this volume from the bulk volume of the granulate gives the new volume of the granulate which comprises the closed pores, open pores with opening diameters less than 2 micrometres and the volume of the coffee matrix. The volume of the closed pores and open pores with opening larger than 2 micrometres in the granulate is obtained by subtracting the volume of the coffee matrix from the new volume of the granulate. The volume of the coffee matrix is obtained from the weight of the sample and coffee matrix density (see Example 2). The foaming porosity is the ratio of the volume of closed pores and open pores having an opening diameter of less than 2 micrometres over the new volume of the granulate.

Reconstitution kinetics were evaluated by conductivity. A 10 Hz conductivity probe (Pt1000/B/2 0-70° C., Metrohm) was used in combination with an acquisition module (module 856, Metrohm). The probe was placed horizontally in a double-wall glass vessel with temperature regulation at 80° C. 10 g of coffee powder was poured onto 400 ml of demineralized water heated at 80° C. prior to the experiment. The solution was stirred at 500 rpm with a magnetic stirrer and 100 rpm with an overhead stirrer to force rapid immersion of all particles. The time too, corresponding to the time between the first change of conductivity and the time at which the conductivity is equal to 90% of the final solution conductivity, was recorded.

Results for the samples are listed in the table below.

| Sample | PriorArt i | A | B (comp.) | C | D | E (comp.) | F | G |
|---|---|---|---|---|---|---|---|---|
| Total open pore volume | 1.64 | 1.47 | 1.29 | 1.34 | 1.42 | 1.18 | 1.34 | 1.48 |
| (ml/g) | | | | | | | | |
| Open pore volume | 9.9 | 6.8 | 3.3 | 5.7 | 6.2 | 3.4 | 5.5 | 6.3 |
| median diameter (μm) | | | | | | | | |
| Foaming porosity | 24% | 36% | 38% | 40% | 41% | 34% | 36% | 42% |
| Intrusion under a | 93% | 84% | 74% | 75% | 76% | 77% | 80% | 75% |
| pressure of 90 psia | | | | | | | | |
| Open pore volume, | 0.11 | 0.28 | 0.34 | 0.33 | 0.35 | 0.28 | 0.27 | 0.38 |
| opening <2 μm (ml/g) | | | | | | | | |
| Intrusion under a | 81% | 68% | 26% | 58% | 58% | 27% | 58% | 57% |
| pressure of 40 psia | | | | | | | | |
| Open pore volume, | 0.31 | 0.41 | 0.96 | 0.59 | 0.60 | 0.88 | 0.57 | 0.64 |
| opening <4.5 μm (ml/g) | | | | | | | | |
| Dissolution t90 [s] at | 6.4 | 7.6 | 13.6 | 12.3 | 8.6 | 14.6 | 14.7 | 9.35 |
| 80° C. | | | | | | | | |

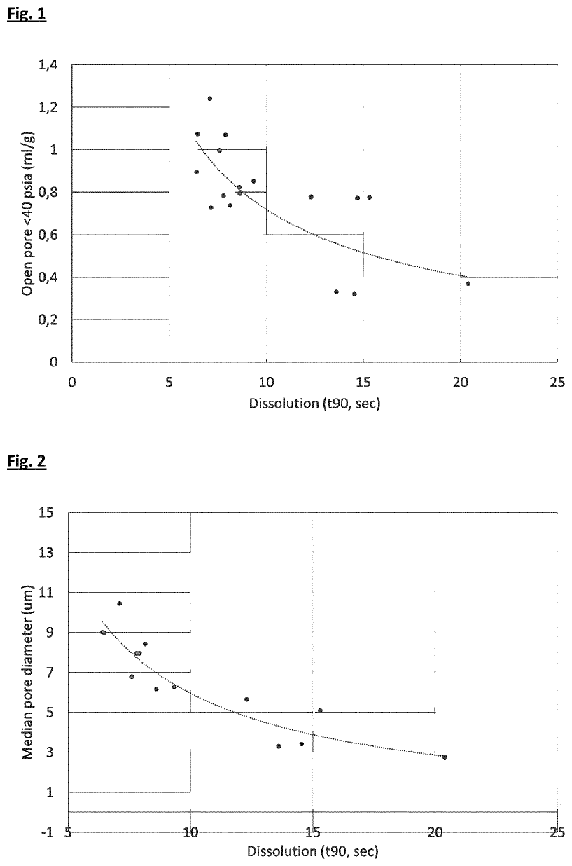

A series of porous freeze-dried coffee powders with the same particle size were prepared to investigate the influence of pore structure on dissolution. The time to 90% dissolution (t₉₀) was found to be lower for coffees having a higher intrusion under a pressure of 40 psia (FIG. 1). Also, the time to 90% dissolution was found to be lower for coffees having a higher median open pore diameter (FIG. 2).

### Example 4: X-Ray Tomography

Multi-resolution X-ray tomography of coffee particles were performed at the TOMCAT beamline of the Swiss Light Source (SLS) at the Paul Scherrer Institut (PSI). For each sample, five coffee particles were stacked in a Kapton tube with 4 mm diameter attached to a brass sample holder. Polymeric foams were placed as spacers in between the particles.

Low-resolution tomography of each particle were performed using a detector with an effective isotropic voxel size of 1.625 μm. A PCO.edge 5.5 sCMOS camera (PCO, Kelheim, Germany) was coupled to a 100-μm thick LuAG:Ce scintillator using a high-quality microscope (Optique Peter, Lentilly, France) with a 4× objective. The camera has 2560×2160 pixels giving an effective field of view of 4.16 mm (horizontal)×3.51 mm (vertical). The X-ray beam energy used was 12 keV, and the sample-to-detector distance was 5 mm.

High-resolution tomography was then performed using a detector with an effective isotropic voxel size of 0.325 μm. A PCO.edge 5.5 sCMOS camera (PCO, Kelheim, Germany) was coupled to a 20-μm thick LuAG:Ce scintillator using a high-quality microscope (Optique Peter, Lentilly, France) with a 20× objective. The camera has 2560×2160 pixels giving an effective field of view of 0.83 mm (horizontal)×0.7 mm (vertical). The X-ray beam energy used was 12 keV, and the sample-to-detector distance was 3 mm.

For each configuration, dark field (no X-ray beam) and flat field (no sample in the beam) images were also recorded to correct for the camera noise and inhomogeneities in background intensity. Phase retrieval of the projections using a Paganin algorithm [D. Paganin et al., Journal of Microscopy-Oxford 206 (2002)] was performed before tomographic reconstructions [F. Marone et al., J. Synchrotron Rad. 19 (2012)]. The data of the reconstructed tomography slices were saved in 16-bit TIFF.

Geodict software (Math2Market) was used on the low-resolution images to analyse the microstructure of open and closed pores. A Non-Local Means filter was first applied to the images. The pores were distinguished from the walls by applying an Auto-thresholding (OTSU method) and a mask was applied to focus on the full imaged particle. The granulometry method (PoroDict module) was performed to extract the overall size statistics of all the pores. The volume mean diameter Dᵥ50 of the pores (both open and closed) in the samples together with the span is listed below.

| | PriorArt | | B | | | E | | |
|---|---|---|---|---|---|---|---|---|
| Sample | i | A | (comp.) | C | D | (comp.) | F | G |
| Pore | 32.7 | 20.1 | 33.8 | 19.9 | 23.8 | 35.2 | 20.0 | 23.6 |
| size | | | | | | | | |
| Dᵥ50 | | | | | | | | |
| (μm) | | | | | | | | |
| Span | 2.0 | 2.2 | 3.8 | 4.7 | 6.6 | 3.3 | 8.1 | 3.2 |

### Example 5: Crema Volume Measurement

The amount of crema produced by the different samples was measured with a simple device (FIG. 3) consisting of a reconstitution vessel connected to a water reservoir, which is initially blocked off with a valve. After reconstituting 5 g of coffee powder in 200 ml of deionized water at 85° C., the reconstitution vessel is closed with a special lid that ends in a scaled capillary. The valve between the reconstitution vessel and the water reservoir is then opened and the water (standard tap water at 25° C.) pushes the reconstituted beverage upwards into the capillary, thus facilitating the reading of the crema volume at 25° C.

Results for the samples are listed in the table below.

| | PriorArt | | B | | | E | | |
|---|---|---|---|---|---|---|---|---|
| Sample | i | A | (comp.) | C | D | (comp.) | F | G |
| Crema | 3.7 | 4.3 | 1.8 | 2.9 | 3.4 | 0.6 | 2.8 | 3.9 |
| volume | | | | | | | | |
| 1 minute | | | | | | | | |
| (cm³) | | | | | | | | |
| Crema | 2.9 | 2.4 | 0.0 | 0.6 | 1.4 | 0.3 | 0.6 | 2.1 |
| volume | | | | | | | | |
| 5 minute | | | | | | | | |
| (cm³) | | | | | | | | |

### Example 6: Measurement of Ice Crystal Voids

The size and shape of the voids left by ice were measured by X-ray tomography analysed by image analysis software.

Low resolution X-ray tomography was performed as described in Example 4. Geodict software (Math2Market) was applied to the low-resolution images to analyse the 3D structure of the particles. The different populations of pores were segmented as a function of sphericity values. A Non-Local Means filter was first applied to the images. The pores were distinguished from the walls by applying an Auto-thresholding (OTSU method). The particle was then contoured using the function “flood fill large pores” (200 voxels). The individual pore analysis was performed using the “individual pores” function, selecting a threshold of 14%. The identified pores were then filtered according to two criteria: sphericity below 0.7 and individual equivalent diameter above 25 μm.

The resulting D_{4,3} data for the pores having a sphericity below 0.7 and an individual equivalent diameter above 25 μm are listed in the table below.

| Sample | PriorArt i | A |
|---|---|---|
| D_{4, 3}/μm | 80.1 | 197.4 |

Various features and embodiments of the present invention will now be described with reference to the following numbered paragraphs (paras).
1. A freeze dried coffee powder for providing a coffee beverage with crema, the coffee powder comprising particles having open and closed pores, the particles having an open pore volume mean diameter (for example as measured by mercury porosimetry) greater than 4 micrometres, for example greater than 5 micrometres, for example greater than 6 micrometres, for example greater than 7 micrometres, for example greater than 8 micrometres, for example an open pore volume mean diameter between 4 and 15 micrometres, for example between 5 and 14 micrometres, for further example between 6 and 9 micrometres and a closed porosity of 15.5% or greater (for example as measured by helium pycnometry).
2. The freeze dried coffee powder according to para 1 wherein the coffee powder provides a beverage with crema of at least 2.5 mL, for example at least 3 mL, for example at least 4 mL, for example at least 5 mL, when using 5 g of product in 200 mL of deionised water at 85° C.
3. The freeze dried coffee powder of para 1 or para 2, the particles having a total open pore volume greater than 1 ml/g (for example greater than 1.1 ml/g, for example greater than 1.2 ml/g, for example greater than 1.3 ml/g, for further example greater than 1.4 ml/g) as measured by mercury porosimetry.
4. The freeze dried coffee powder of any one of paras 1 to 3 wherein the particles comprise open pores formed by added ice (for example as measured by X-ray tomography) having a mean volume diameter D_{4,3} of from 50 to 1000 μm, for example from 100 to 1000 μm, for example from 200 to 500 μm, for example from 90 to 250, for example from 110 to 210 μm.
5. The freeze dried coffee powder of any one of paras 1 to 4, the particles comprising pores having a sphericity below 0.7 and an individual equivalent diameter above 25 μm; wherein said open pores having a sphericity below 0.7 and an individual equivalent diameter above 25 μm have a mean volume diameter D_{4,3} of from 50 to 1000 μm, for example from 100 to 1000 μm, for example from 200 to 500 μm, for example from 90 to 250, for example from 110 to 210 μm, as measured by X-ray tomography.
6. The freeze dried coffee powder of any one of paras 1 to 5 wherein the particles have open pores with openings smaller than 2 micrometres, the volume of the open pores with openings smaller than 2 micrometres being greater than 17% of the total volume of open pores as measured by mercury porosimetry.
7. The freeze dried coffee powder of any one of paras 1 to 6 wherein wherein the particles comprise open and closed pores, together the open and closed pores having an overall pore size distribution with a volume median diameter Dv50 of from 10 to 100 micrometres, for example 30 to 50 micrometres, for example 10 to 45 micrometres.
8. The freeze dried coffee powder of any one of paras 1 to 7 wherein the particles have a structure such that 60% or more intrusion of the particles is achieved under a pressure of 40 psia by mercury porosimetry.
9. Use of the freeze dried coffee powder of any one of paras 1 to 8 to prepare a coffee beverage having crema.
10. A beverage powder mixture comprising the freeze dried coffee powder of any one of paras 1 to 8.

1. A coffee powder for providing a coffee beverage with crema, the coffee powder comprising particles having open and closed pores, the particles having an open pore volume mean diameter greater than 4 micrometres, a total open pore volume greater than 1 ml/g and a foaming porosity of 30% or greater.

2. The coffee powder of claim 1 wherein the coffee powder is a freeze-dried coffee powder.

3. The coffee powder of claim 1, the particles comprising pores having a sphericity below 0.7 and an individual equivalent diameter above 25 μm; wherein said pores having a sphericity below 0.7 and an individual equivalent diameter above 25 μm have a mean volume diameter D_{4,3} of from 50 to 1000 μm as measured by X-ray tomography.

4. The coffee powder of claim 1 wherein the particles have a closed porosity of 8% or greater.

5. The coffee powder of claim 1 wherein the particles have open pores with openings smaller than 2 micrometres, the volume of the open pores with openings smaller than 2 micrometres being greater than 17% of the total volume of open pores.

6. The coffee powder of claim 1 wherein the particles comprise open and closed pores, together the open and closed pores having an overall pore size distribution with a volume median diameter Dv50 of from 10 to 100 micrometres.

7. The coffee powder of claim 1 wherein the particles have a structure such that 60% or more intrusion of the particles is achieved under a pressure of 40 psia by mercury porosimetry.

8. The coffee powder of claim 1 wherein the particles have an open pore volume mean diameter between 4 and 15 micrometres.

9-10. (canceled)

11. A method for the manufacture of a freeze-dried coffee powder, the method comprising;
providing a coffee extract having from 50 wt % to 70 wt % solids;
adding gas to the coffee extract in an amount of from 0.5 to 3 normal litres per kilogram of solids, to provide a gas-containing coffee extract at above atmospheric pressure;
cooling the gas-containing coffee extract to a temperature of −10 to 10° C.;
depressurising the gas-containing coffee extract to form a foamed coffee extract;
adding crystals of a material capable of sublimation to the foamed coffee extract at a temperature of −10 to 10° C. to form a mixture comprising foamed coffee extract and crystals of a material capable of sublimation;
cooling the mixture comprising foamed coffee extract and crystals of a material capable of sublimation to below −30° C. to form a solid coffee extract,
fragmenting the solid coffee extract; and
placing the solid coffee extract under conditions wherein the crystals of a material capable of sublimation sublime.

12. The method of claim 11 wherein the ratio of crystals capable of sublimation to coffee extract is in the range 5 to 40 wt. %.

13. The method of claim 11 wherein the crystals of a material capable of sublimation are ice, the solid coffee extract is frozen coffee extract and the solid coffee extract is dried under vacuum.

14. The method of claim 13 wherein the ice has a mean volume diameter from 45 to 2000 μm.

15. The method of claim 13 wherein the ice is added in the form of a frozen aroma extract.
